(19) United States
(12) Patent Application Publication
(10) Pub. No.: US 2015/0092527 A1
(43) Pub. Date: Apr. 2, 2015

(54) OPTICAL DISC APPARATUS AND RECORDING METHOD OF OPTICAL DISC

(71) Applicant: Sony Corporation, Tokyo (JP)

(72) Inventor: Toshiyuki Murayama, Kanagawa (JP)

(21) Appl. No.: 14/491,366

(22) Filed: Sep. 19, 2014

(30) Foreign Application Priority Data
Sep. 27, 2013 (JP) 2013-201330

(51) Int. Cl. G11B 7/1267

(52) U.S. Cl. CPC G11B 7/1267
USPC 369/47.53

(57) ABSTRACT

An optical disc apparatus includes a plurality of optical heads; an optical head control section that performs an optical output configuration process for each of the plurality of optical heads by using a test writing region provided in an optical disc, wherein the optical output configuration process sets an optimum recording power for each of the plurality of optical heads; and an integrated control section that controls the optical head control section such that a first optical output configuration process for each of the plurality of optical heads is performed in parallel and a second optical output configuration process is performed for at least one optical head of the plurality of optical heads based on a result of the first optical output configuration process.

### CROSS REFERENCE TO RELATED APPLICATIONS

This application claims the benefit of Japanese Priority Patent Application JP 2013-201330 filed Sep. 27, 2013, the entire contents of which are incorporated herein by reference.

### FIELD

The present technology relates to an optical disc apparatus and a recording method of an optical disc, and specifically, relates to a technology that sets optimum power of each optical head when recording information on an optical disc by using a plurality of optical heads.

### BACKGROUND

In the related art, an optical disc apparatus recording information on a writable optical disc performs an optical output setting process to set optimum power for recording (hereinafter, referred to as OPC: Optimum Power Calibration) prior to recording.

Further, in the optical disc apparatus, in order to speed up a bit rate for recording/reproducing of the information, a plurality of optical heads are simultaneously operated with respect to one sheet of the optical disc by providing a plurality of optical heads. For example, in Japanese Unexamined Patent Application Publication No. 2006-286063 and Japanese Unexamined Patent Application Publication No. 2012-133844, the OPC is performed and each optical head is set to optimum recording power in the optical disc apparatus in which a plurality of optical heads are provided.

### SUMMARY

However, if the plurality of optical heads provided in the optical disc apparatus are set to optimum recording power, it is preferable that each optical head can be easily set to optimum recording power. Further, it is preferable that the OPC can be completed in a short amount of time regardless of the number of the optical heads.

Thus, in the present technology, it is desirable to provide an optical disc apparatus that can easily set an optimum power of each optical head in a short amount of time when recording information on an optical disc by using a plurality of optical heads, and a recording method of the optical disc.

According to an embodiment of the present technology, there is provided an optical disc apparatus including: a plurality of optical heads; an optical head control section that performs a first optical output configuration process for each of the plurality of optical heads by using a test writing region provided in an optical disc, wherein the first optical output configuration process sets an optimum recording power for each of the plurality of optical heads; and an integrated control section that controls the optical head control section such that the first optical output configuration process for each of the plurality of optical heads is performed in parallel and a second optical output configuration process is performed for at least one optical head of the plurality of optical heads based on a result of the first optical output configuration process.

In the present technology, the optical output setting process is performed for each of the plurality of optical heads by using the test writing region provided in the optical disc. The optical head control section performs the setting of the optimum recording power for each of the optical heads and the integrated control section performs in parallel the optical output setting process for each of the plurality of optical heads. The optical head control section obtains writing quality in the optical output setting process and if the writing quality does not satisfy a desired quality, an appropriate recording power setting is not performed. If it is determined that the optical head in which setting of the optimum recording power is not performed is present, the integrated control section retries resetting the optimum recording power based on the result of the previous optical output setting process. In the retry process, if it is determined that a plurality of optical heads in which the resetting is necessary are present, the optical output setting process is performed in parallel. The number of the retries is limited to a predetermined number of times. Further, if a write-once optical disc is used as the optical disc, the integrated control section continuously sets a use region that is used for the optical output setting process to a used region in the test writing region. Further, if a rewritable optical disc is used, the integrated control section randomly sets the use region that is used for the optical output setting process in the test writing region. Further, the integrated control section performs a process for distributing information recorded on the optical disc to a plurality of heads and a process for returning the order of the information that is read from the optical disc to the order thereof before the recording in the plurality of optical heads is performed.

According to another embodiment of the present technology, there is provided a recording method of an optical disc including: performing, in parallel, a first optical output configuration process for each of a plurality of optical heads by using a test writing region provided in the optical disc, wherein the first optical output configuration process sets an optimum recording power for at least one of the plurality of optical heads in an optical head control section; and performing a second optical output configuration process for at least one optical head of the plurality of optical heads, based on a result of the first optical output configuration.

According to the embodiment of the present technology, the optical output setting process is performed for each of the plurality of optical heads and the setting of the optimum recording power is performed for each of the optical heads by using the test writing region provided in the optical disc. The optical output setting process for each of the plurality of optical heads is performed in parallel and the optical output setting process is again performed in parallel if it is determined that a plurality of optical heads which are necessary for the resetting are present based on the setting process result. Thus, it is possible to easily set the optimum power of each of the optical heads in a short time when recording the information on the optical disc by using the plurality of optical heads. Moreover, advantages described in the specification are only exemplary and are not intended to limit the present technology, and an additional advantage may be present.

### BRIEF DESCRIPTION OF THE DRAWINGS

FIGS. 1A and 1B are views illustrating a configuration example of an optical disc apparatus;

FIG. 2 is a view illustrating a block configuration regarding a drive control of an optical head;

FIG. 3 is a block diagram illustrating a configuration of the optical head and an optical head control section;

FIG. 4 is a flowchart illustrating an operation of an integrated control section;

FIG. 5 is a sequence diagram illustrating an OPC operation;

FIGS. 6A to 6E are views illustrating a region used for OPC;

FIG. 7 is a flowchart illustrating the OPC operation in which setting of an OPC execution address is facilitated; and

FIGS. 8A and 8B are views illustrating another configuration example of an optical disc apparatus.

### DETAILED DESCRIPTION OF EMBODIMENTS

Hereinafter, an embodiment of the present technology is described. Moreover, the description is made in the following order.

1. Configuration of Embodiment

2. OPC

3. Other Embodiments

### 1. Configuration of Embodiment

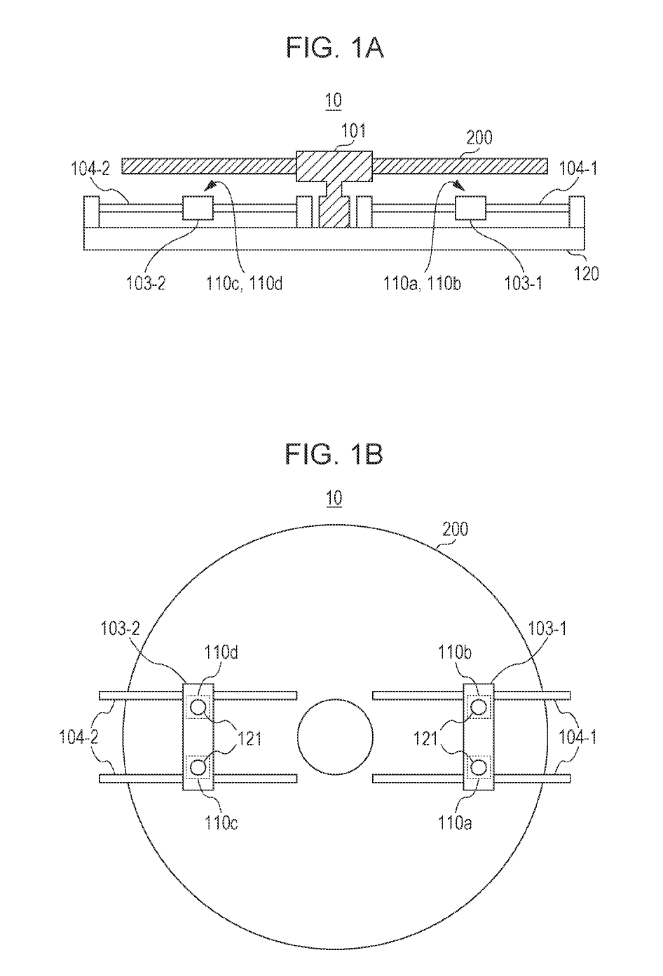

FIGS. 1A and 1B illustrate a configuration example of an optical disc apparatus as an embodiment of the present technology. An optical disc apparatus 10 illustrated in FIGS. 1A and 1B performs writing of information by emitting laser light with respect to an optical disc 200 which is mounted. The optical disc 200 is a writable optical disc. In the embodiment, a case where the optical disc 200 is a Blu-ray (registered trademark) disc is described as an example, but the present technology is not limited to the example and the present technology may be applied to another standard optical disc such as a compact Disc (CD) or a Digital Versatile Disc (DVD).

FIG. 1A is a side view illustrating the optical disc apparatus 10 and FIG. 1B is a top view illustrating the optical disc apparatus 10.

As illustrated in FIG. 1A, the optical disc apparatus 10 includes a pedestal 120, a spindle motor 101 that rotates the optical disc 200 that is mounted, and optical heads 110a to 110d which emit the laser light to the optical disc 200. The optical heads 110a and 110c are illustrated in FIG. 1A, but as illustrated in FIG. 1B, the optical head 110b is disposed in the position of the optical head 110a in a depth direction in the view and the optical head 110d is disposed in the position of the optical head 110c in the depth direction in the view.

As illustrated in FIG. 1B, the optical heads 110a and 110b include object lenses 121; each of the object lenses 121 focuses the laser light output from a laser light output section (not illustrated) and emits the laser light to the optical disc 200. Then, the optical heads 110a and 110b having the object lenses 121 are mounted on a threaded carriage 103-1 in parallel in a circumferential direction. The threaded carriage 103-1 is attached on a shaft 104-1 in a state of being horizontally movable with respect to the optical disc 200 in a radial direction of the optical disc 200. The shaft 104-1 has a length corresponding to a radius of the optical disc 200. Then, the threaded carriage 103-1 is driven based on control of a servo control section (not illustrated) so that the optical heads 110a and 110b mounted on the threaded carriage 103-1 move on the shaft 104-1 in the radial direction of the optical disc 200.

The optical heads 110c and 110d include object lenses 121 and the object lens 121 focuses the laser light output from the laser light output section (not illustrated) and emits the laser light to the optical disc 200. Then, the optical heads 110c and 110d having the object lenses 121 are mounted on a threaded carriage 103-2 in parallel in a circumferential direction. The threaded carriage 103-2 is attached on a shaft 104-2 in a state of being horizontally movable with respect to the optical disc 200 in the radial direction of the optical disc 200. The shaft 104-2 has a length corresponding to the radius of the optical disc 200 and, for example, is provided in a symmetrical position with respect to the shaft 104-1 with reference to a rotating shaft of the optical disc 200. Then, the threaded carriage 103-2 is driven based on a control of the servo control section (not illustrated) so that the optical heads 110c and 110d mounted on the threaded carriage 103-2 move on the shaft 104-2 in the radial direction of the optical disc 200.

According to the optical disc apparatus 10 configured as described above, the optical disc 200 is rotated by the spindle motor 101 and the laser light output from the optical heads 110a to 110d is emitted on the circumference of the optical disc 200. Further, the threaded carriage 103-1 moves on the shaft 104-1 and the threaded carriage 103-2 moves on the shaft 104-2 so that all tracks from an internal circumference to an outer circumference of the optical disc 200 are traced.

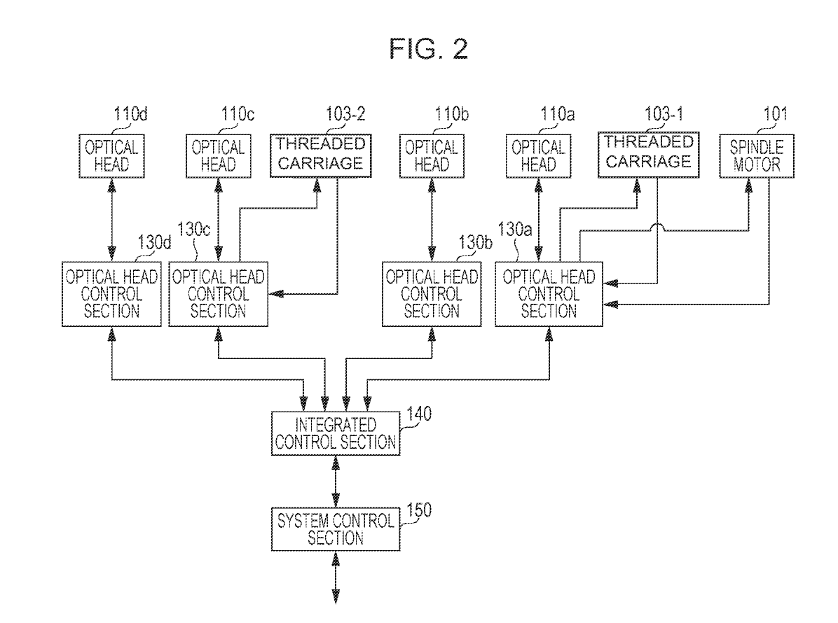

FIG. 2 is a view illustrating a block configuration regarding drive control of an optical head. The control block has optical head control sections 130a to 130d, an integrated control section 140, and a system control section 150.

The optical head control section 130a performs drive control of the optical head 110a, drive control of the spindle motor 101, and drive control of the threaded carriage 103-1. The optical head control section 130b performs drive control of the optical head 110b. The optical head control section 130c performs drive control of the optical head 110c and drive control of the threaded carriage 103-2. The optical head control section 130d performs drive control of the optical head 110d.

In order to make the laser light an optimum recording power prior to recording, the optical head control section 130a performs an optical output setting, or configuration, process (OPC: Optimum Power Calibration) of the optical head 110a by using a test writing region provided in the optical disc 200. Similarly, the optical head control sections 130b to 130d perform the OPC of the optical heads 110b to 110d by using the test writing region provided in the optical disc 200. Moreover, in the following description, a signal processing system handled on the side of the optical head 110a is referred to as a channel CHa and a signal processing system handled on the side of the optical head 110b is referred to as a channel CHb. Further, a signal processing system handled on the side of the optical head 110c is referred to as a channel CHc and a signal processing system handled on the side of the optical head 110d is referred to as a channel CHd.

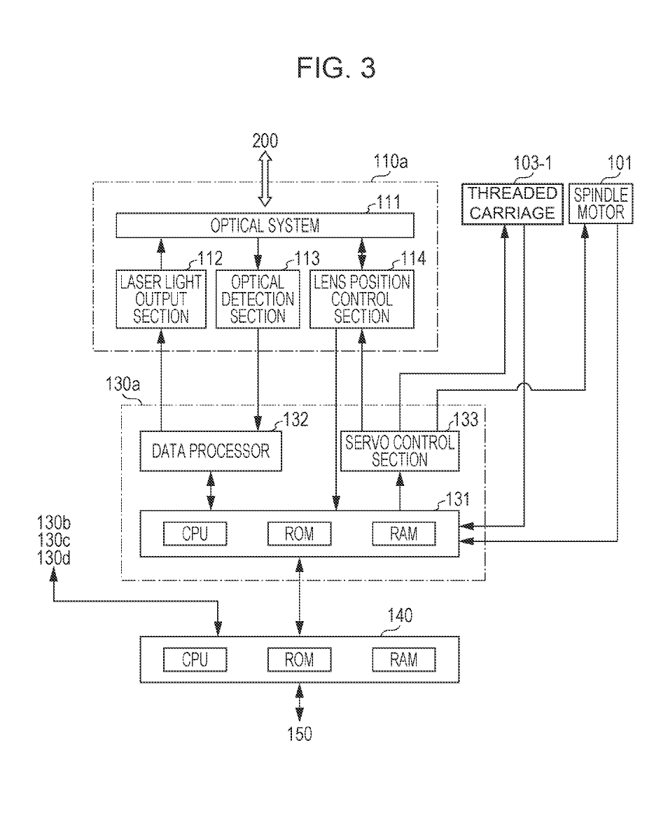

FIG. 3 is a block diagram illustrating a configuration of the optical head and the optical head control section. Moreover, in FIG. 3, the configuration of the optical head 110a and the optical head control section 130a is illustrated.

The optical head 110a includes an optical system 111, a laser light output section 112, an optical detection section 113, and a lens position control section 114. The optical system 111 includes an objective lens (see FIGS. 1A and 1B), a beam splitter, a mirror, or the like. Then, the laser light output from the laser light output section 112 is focused on the objective lens and is emitted to the optical disc 200 (see FIGS. 1A and 1B), and the light returned from the optical disc 200 is input to the optical detection section 113. The laser light output section 112 is configured of a laser diode and the like and converts digital data supplied from the optical head control section 130a into an optical signal (laser light) and then outputs the optical signal to the optical system 111 by the recording power. Further, the laser light output section 112 outputs the laser light that is adjusted to a reproduction power at the time of reproduction to the optical system 111. The reproduction power is a light emitting power when reading the information recorded on the optical disc 200, and strength thereof is controlled by a recording reproduction control section 131 of the optical head control section 130a.

The optical detection section 113 of the optical head 110a extracts the light returned from the optical disc 200 of the laser light that is adjusted to read power as the optical signal and converts the optical signal into an electric signal and then supplies the electric signal to a data processor 132 of the optical head control section 130a. Therefore, the data recorded on the optical disc 200 is read in the optical disc apparatus 10. The lens position control section 114 is an actuator that controls a position of the objective lens. The lens position control section 114 controls the position of the objective lens so that a radiation position of the laser light emitted to the optical disc 200 becomes a desired position.

Next, a configuration of the optical head control section 130a is described. The optical head control section 130a includes the recording reproduction control section 131, the data processor 132 and a servo control section 133.

For example, the recording reproduction control section 131 has Central Processing Unit (CPU), Read Only Memory (ROM), and Random Access Memory (RAM). The CPU performs various types of processes according to programs stored in the ROM, or programs loaded on the RAM. For example, the operation of the data processor 132 and the servo control section 133 is controlled so as to record or reproduce the information that is instructed, based on instruction from the recording reproduction control section 131 and the integrated control section 140. Further, the recording reproduction control section 131 performs the OPC by using the region indicated by the OPC execution address notified from the integrated control section 140, and notifies the integrated control section 140 of a setting process result. For example, when writing quality supplied from the data processor 132 satisfies a desired quality, the recording reproduction control section 131 sets the recording power in which a measured result is the best quality as the best recording power. Further, when the writing quality does not satisfy a desired quality, the recording reproduction control section 131 does not perform the setting of the optimum recording power. The recording reproduction control section 131 outputs the setting process result of the OPC to the integrated control section 140. Moreover, when a retry of the OPC is performed as described below, the recording reproduction control section 131 may change a range of recording power or test data and the like. Further, data or the like necessary for executing various types of processes in the CPU is appropriately stored in the RAM.

The data processor 132 performs an information process that makes the information read by the optical disc 200 or the information written on the optical disc 200 a target to be processed by being controlled by the recording reproduction control section 131. Further, the data processor 132 outputs the writing quality to the recording reproduction control section 131 by obtaining the writing quality in the OPC. For example, the data processor 132 performs measurement of asymmetry, a jitter value, RF signal amplitude, an error rate, a β value and the like by reproducing the test data recorded in the OPC, and a measured result is output to the recording reproduction control section 131 as the writing quality.

The servo control section 133 generates a spindle control signal based on the control of the recording reproduction control section 131 and supplies the spindle control signal to the spindle motor 101 (see FIGS. 1A and 1B) so that the optical disc 200 is rotated at a desired speed. Further, the servo control section 133 generates a threaded carriage control signal based on the control of the recording reproduction control section 131 and supplies the threaded carriage control signal to the threaded carriage 103-1 (see FIGS. 1A and 1B). As described above, the servo control section 133 allows the threaded carriage 103-1 to move by supplying the threaded carriage control signal so that the reading of the information recorded in a desired position or the recording of the information on a desired position of the optical disc 200 is performed by the optical head 110a. Furthermore, the servo control section 133 generates an actuator control signal based on the control of the recording reproduction control section 131 and supplies the actuator control signal to the lens position control section 114. Therefore, the optical system 111 is driven so that the laser light can be emitted from the optical head 110a to a desired position of the optical disc 200.

The optical head 110b and the optical head control section 130b on the side of the channel CHb are configured similarly to the optical head 110a and the optical head control section 130a on the side of the channel CHa. However, there is a single spindle motor 101 and the optical head 110a and the optical head 110b are provided in the threaded carriage 103-1. Therefore, the control of the spindle motor 101 and the control of the threaded carriage 103-1 are performed only by the servo control section 133 of the optical head control section 130a.

Similarly, the optical head 110c and the optical head control section 130c on the side of the channel CHc have the same configuration as that of the optical head 110a and the optical head control section 130a on the side of the channel CHa. However, there is a single spindle motor 101 and the optical head 110a and the optical head 110c are provided on the other threaded carriage. Therefore, the control of the spindle motor 101 is performed only by the servo control section 133 of the optical head control section 130a, and the control of the threaded carriage 103-2 is performed by the servo control section 133 of the optical head control section 130c.

Further, the optical head 110d and the optical head control section 130d on the side of the channel CHd are configured similarly to the optical head 110a and the optical head control section 130a on the side of the channel CHa. However, there is a single spindle motor 101 and the optical head 110c and the optical head 110d are provided in the threaded carriage 103-2. Therefore, the control of the spindle motor 101 is performed only by the servo control section 133 of the optical head control section 130a and the control of the threaded carriage 103-2 is performed only by the servo control section 133 of the optical head control section 130c.

The integrated control section 140 has a Central Processing Unit (CPU), a Read Only Memory (ROM) and a Random Access Memory (RAM). The CPU performs various types of processes according to programs stored in the ROM, or programs loaded on the RAM. The integrated control section 140 distributes the process that is performed to the optical head control sections 130a to 130d based on a command from the system control section 150 described below. For example, when supplying a writing command from the system control section 150, the integrated control section 140 distributes the information to be recorded to the optical head control sections 130a to 130d and the information is recorded in parallel on the optical disc 200 by using the optical heads 110a to 110d. As described above, a plurality of optical heads are used in parallel so that the recording of the information is quickly performed in the optical disc apparatus. Further, for example, when a reading command is supplied from the system control section 150, the integrated control section 140 distributes the reading process of the information to the optical head control sections 130a to 130d, and reads the information in parallel from the optical disc 200 by using the optical heads 110a to 110d. Further, the integrated control section 140 outputs the information that is read in parallel from the optical disc 200 by using the optical heads 110a to 110d to the system control section 150 by returning the order of the information to the sequential order thereof before the reading. As described above, the integrated control section 140 uses the plurality of optical heads in parallel so that the reading of the information is quickly performed in the optical disc apparatus.

Further, the integrated control section 140 sets a region that is used for the OPC within the OPC region that is the test writing region of the optical disc 200 for each of the plurality of optical heads. The integrated control section 140 performs the OPC (i.e. a first optical output configuration process) in parallel in the plurality of optical heads and again performs (hereinafter, referred to as “retry” or as a “second optical output configuration process”) the OPC by newly setting the region that is used with respect to the optical head which is determined to be reset based on the setting process result of the OPC. When the plurality of optical heads are retried, the integrated control section 140 performs the retry in parallel. Further, when setting of the optimum recording power is completed in all channels, the integrated control section 140 finishes the OPC and notifies the system control section 150 of the setting process result. Further, when the optimum recording power may not be set even if the retry is performed for the predetermined number of times, the integrated control section 140 finishes the OPC and notifies the system control section 150 of the setting process result.

When recording instruction of the information is issued from an outer device or the like, the system control section 150 outputs the writing command performing the recording of the information and the recording information from a position on the optical disc 200 that is instructed by the recording instruction to the integrated control section 140. Further, a reproduction instruction may be issued from the outer device or the like, and the system control section 150 outputs the reading command performing the reading of the information from a position on the optical disc 200 that is instructed by the reproduction instruction to the integrated control section 140. Further, the system control section 150 outputs the information that is read from the optical disc 200 depending on the reading command and supplied from the integrated control section 140 to the exposure device or the like in which the recording instruction is performed.

### 2. OPC

In the optical disc apparatus 10 configured as described above, before a writing process is performed, an OPC may be performed which is the process in which the laser light is set to optimum recording power during writing. The control of the OPC is performed in the optical head control sections 130a to 130d and the integrated control section 140. Basic flows of OPC sequence are as follows.

(1) An OPC execution address is determined for each channel.

(2) The test data is recorded on the optical disc 200 in the recording power that is adjusted for OPC evaluation by using a predetermined region based on the position of the OPC execution address that is determined.

(3) Reading of the test data that is recorded is performed.

(4) Setting of the optimum recording power is performed under the writing quality obtained based on a Radio Frequency (RF) signal that is read.

(5) When the setting of the optimum recording power is not completed, the OPC is repeated for a predetermined number of times until the setting of the optimum recording power is completed. When a plurality of channels in which the setting of the optimum recording power is not completed are present, the OPC is performed in parallel.

For example, in a case of the channel CHa, the setting of power necessary for the execution of the OPC is performed with respect to the optical head 110a by the recording reproduction control section 131 of the optical head control section 130a. The execution address necessary for the execution of the OPC is performed by using the OPC execution address that is instructed from the integrated control section 140. Further, a command signal instructing a recording start timing or a power conversion timing necessary for the execution of the OPC, the test data for the writing, or the like is supplied to the optical head 110a by the data processor 132. The test data practically corresponds to a signal that is written to the optical disc 200 and is supplied to the laser light output section 112 inside the optical head 110a through a write strategy circuit (not illustrated). A function for obtaining the writing quality based on a reproduction RF signal necessary for the execution of the OPC is implemented in the data processor 132. Then, the recording reproduction control section 131 controls each section so as to obtain the writing quality at appropriate timing by receiving the timing from the data processor 132. The recording reproduction control section 131 performs the setting of the optimum recording power based on the writing quality that is obtained and outputs the setting process result to the integrated control section 140. Similar to the channels CHb to CHd, the recording reproduction control section 131 of the optical head control sections 130b to 130d performs the process described above by using the optical heads 110b to 110d based on the instruction from the integrated control section 140.

The integrated control section 140 performs the OPC in parallel in the channels CHa to CHd and obtains the setting process result. Further, when there exists a channel in which the setting of the optimum recording power has not been completed, in the integrated control section 140, the retry of the OPC is performed for the channel in which the setting was not completed. Further, when a plurality of channels exist in which the setting of the optimum recording power has not been completed, the integrated control section 140 performs the retry in parallel. When the setting of the optimum recording power has been completed in all channels or when the setting of the optimum recording power is not completed although the retry is repeated a predetermined times, the integrated control section 140 finishes the OPC.

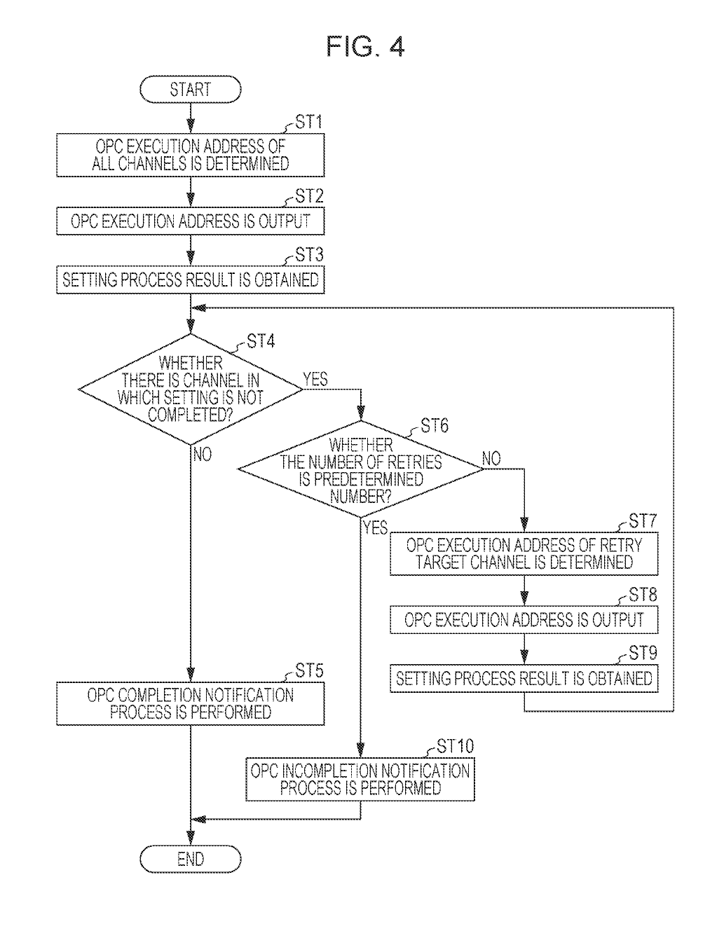

FIG. 4 is a flowchart illustrating a control operation of the OPC of the integrated control section. In step ST1, the integrated control section 140 determines the OPC execution address of all channels. For example, as described above, when the recording is performed by using the channels CHa to CHd, the integrated control section 140 determines the OPC execution address (for example, an OPC start address) for each of the channels CHa to CHd and the process proceeds to step ST2.

In step ST2, the integrated control section 140 outputs the OPC execution address. The integrated control section 140 outputs the OPC execution address of the channel CHa to the optical head control section 130a and performs the OPC by using the optical head 110a. Similarly, the integrated control section 140 outputs the OPC execution address of the channels CHb to CHd to the optical head control sections 130b to 130d and performs the OPC by using the optical heads 110b to 110d, and the process proceeds to step ST3.

In step ST3, the integrated control section 140 obtains the setting process result. The integrated control section 140 obtains the setting process result from the optical head control sections 130a to 130d, and the process proceeds to step ST4.

In step ST4, the integrated control section 140 determines whether there is a channel in which the setting of the optimum recording power is not completed. When the integrated control section 140 indicates that all setting process results obtained in step ST3 or step ST9 described below are the completion of the setting of the optimum recording power, the process proceeds to step ST5. Further, when the setting process result that does not indicate the completion of the setting of the optimum recording power is included, the integrated control section 140 makes the channel in which the setting is not completed the channel of the retry target and the process proceeds to step ST6.

In step ST5, the integrated control section 140 performs an OPC completion notice process. The integrated control section 140 notifies the system control section 150 that the setting of the optimum recording power is completed in all channels and the OPC control operation is finished.

If the process proceeds from step ST4 to step ST6, in step ST6, the integrated control section 140 determines whether the number of the retries has reached the predetermined number of retry times. When the integrated control section 140 determines that the number of the retries in the channel of the retry target does not reach the predetermined number of times, the process proceeds to step ST7, and when the integrated control section 140 determines that the number of the retries in the channel of the retry target reaches the predetermined number of times, the process proceeds to step ST10.

In step ST7, the integrated control section 140 determines the OPC execution address of the channel of the retry target. The integrated control section 140 determines the OPC execution address only for the channel that is determined as the retry target in step ST4 and the process proceeds to step ST8.

In step ST8, the integrated control section 140 outputs the OPC execution address. The integrated control section 140 outputs the OPC execution address determined for each channel of the retry target to the optical head control section of the channel of the retry target and performs the OPC by using the optical head, and the process proceeds to step ST9. Here, when a plurality of channels of the retry target are present, the OPC is performed in parallel.

In step ST9, the integrated control section 140 obtains the setting process result. The integrated control section 140 obtains the setting process result from the optical head control section of the channel of the retry target and the process returns to step ST4.

In step ST6, when the process proceeds to step ST10 by determining that the number of the retries reaches the predetermined number of times, the integrated control section 140 performs an OPC incompletion notice process. The integrated control section 140 notifies the system control section 150 that the channel in which the setting of the optimum recording power is not completed occurs or notifies of the channel in which the setting is not completed, and the OPC control operation is finished.

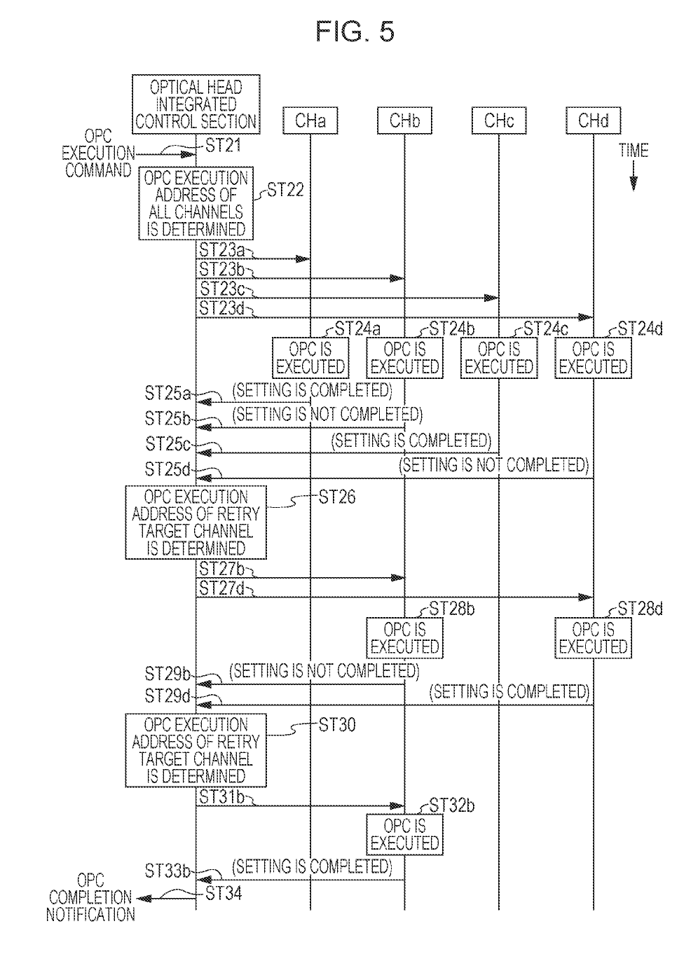

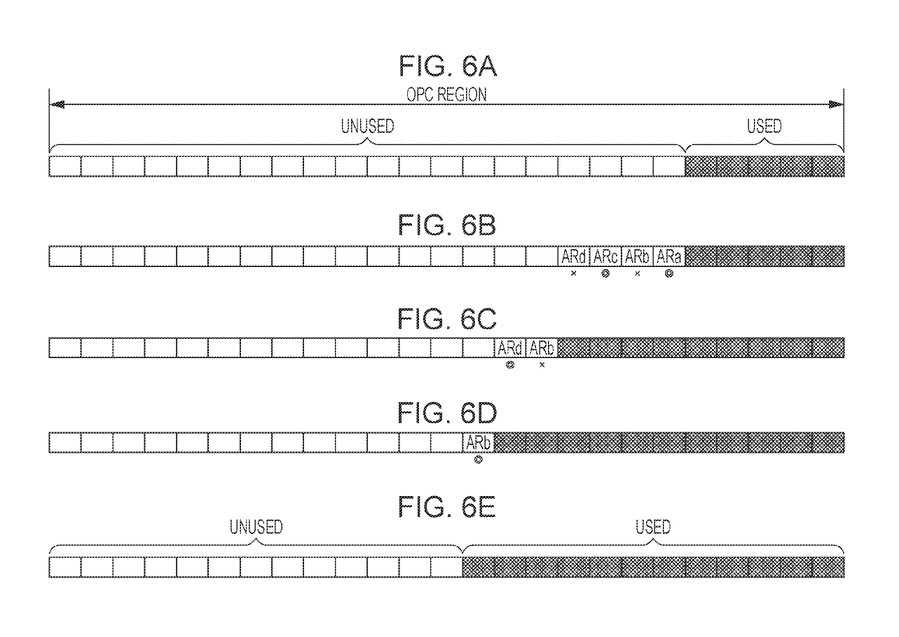

Next, an operation example of the OPC is described with reference to FIGS. 5 to 6E. Moreover, in FIGS. 5 to 6E, a case where a write-once optical disc is used as the optical disc 200 is illustrated. Further, a case where the retry is performed two times in the channel CHb, and the retry is performed one time in the channel CHd, and then the OPC of the channels CHa to CHd is completed is illustrated.

FIG. 5 is a sequence diagram illustrating the OPC operation. FIGS. 6A to 6E illustrate a region used for the OPC.

In FIG. 5, when the OPC execution command is supplied from the system control section 150 in step ST21, the integrated control section 140 determines the OPC execution address of all channels in step ST22. As illustrated in FIG. 6A, for example, in the optical disc 200, a used region is generated in the OPC region. In this case, as illustrated in FIG. 6B, the integrated control section 140 determines the OPC execution address of all channels so that a use region ARa of the channel CHa and use regions ARb to ARd of the channels CHb to CHd are sequentially provided continuously to the used region.

Referring back to FIG. 5, the integrated control section 140 outputs the OPC execution address to the channel CHa in step ST23a. Further, the integrated control section 140 outputs the OPC execution address to the channels CHa to CHd in step ST23b to step ST23d.

The channel CHa performs the OPC in step ST24a. The optical head 110a and the optical head control section 130a of the channel CHa perform the OPC by using a use region ARa indicated by the OPC execution address notified from the integrated control section 140 and output the setting process result to the integrated control section 140 in step ST25a. Moreover, in the channel CHa, the setting of the optimum recording power is completed.

The channel CHb performs the OPC in step ST24b. The optical head 110b and the optical head control section 130b of the channel CHb perform the OPC by using a use region ARb indicated by the OPC execution address notified from the integrated control section 140 and output the setting process result to the integrated control section 140 in step ST25b. Moreover, in the channel CHb, the setting of the optimum recording power is not completed.

The channel CHc performs the OPC in step ST24c. The optical head 110c and the optical head control section 130c of the channel CHc perform the OPC by using a use region ARc indicated by the OPC execution address notified from the integrated control section 140 and output the setting process result to the integrated control section 140 in step ST25c. Moreover, in the channel CHc, the setting of the optimum recording power is completed.

The channel CHd performs the OPC in step ST24d. The optical head 110d and the optical head control section 130d of the channel CHd perform the OPC by using a use region ARd indicated by the OPC execution address notified from the integrated control section 140 and output the setting process result to the integrated control section 140 in step ST25d. Moreover, in the channel CHd, the setting of the optimum recording power is not completed.

In FIGS. 6B to 6D, a first mark, such as mark ⊚ indicates that the setting of the optimum recording power is completed. Further, a second mark, such as mark X indicates that the setting of the optimum recording power is not completed. Therefore, in a case illustrated in FIG. 6B, the channel CHb and the channel CHd become the channels of the retry target.

Referring back to FIG. 5, the integrated control section 140 performs the determination of the channel of the retry target in step ST26 and determines the OPC execution address for the channel of the retry target. The integrated control section 140 makes the channels CHb and CHd the channels of the retry target because, for example, the setting process result indicates that the setting of the optimum recording power is not completed in the channels CHb and CHd. The integrated control section 140 continuously provides the use region of the channel of the retry target to the used region. That is, as illustrated in FIG. 6C, the integrated control section 140 determines the OPC execution address of the channel of the retry target so that the use region ARb of the channel CHb and the use regions ARd of the channel CHd are sequentially continuously provided to the used region.

Referring back to FIG. 5, the integrated control section 140 outputs the OPC execution address to the channel CHb in step ST27b. Further, the integrated control section 140 outputs the OPC execution address to the channel CHd in step ST27d.

The channel CHb performs the OPC in step ST28b. The optical head 110b and the optical head control section 130b of the channel CHb perform the OPC by using the use region ARb indicated by the OPC execution address notified from the integrated control section 140 and output the setting process result to the integrated control section 140 in step ST29b. Moreover, in the channel CHb, the setting of the optimum recording power is not completed.

The channel CHd performs the OPC in step ST28d. The optical head 110d and the optical head control section 130d of the channel CHd perform the OPC by using the use region ARd indicated by the OPC execution address notified from the integrated control section 140 and output the setting process result to the integrated control section 140 in step ST29d. Moreover, in the channel CHd, the setting of the optimum recording power is completed.

The integrated control section 140 performs the determination of the channel of the retry target in step ST30 and determines the OPC execution address for the channel of the retry target. The integrated control section 140 makes the channel CHb be the channel of the retry target because, for example, the setting process result indicates that the setting of the optimum recording power is not completed in the channel CHb. As illustrated in FIG. 6D, the integrated control section 140 determines the OPC execution address of the channel of the retry target for the channel CHb that is the channel of the retry target so that the use region ARb of the channel CHb is continuously provided to the used region.

The integrated control section 140 outputs the OPC execution address to the channel CHb in step ST31b.

The channel CHb performs the OPC in step ST32b. The optical head 110b and the optical head control section 130b of the channel CHb perform the OPC by using the use region ARb indicated in the OPC execution address notified from the integrated control section 140 and output the setting process result to the integrated control section 140 in step ST33b. Moreover, in the channel CHb, the setting of the optimum recording power is completed.

The integrated control section 140 performs the OPC completion notice process in step ST34 because the setting of the optimum recording power is completed in all channels by performing the retry, and notifies the system control section 150 of completion of the setting in all channels. Moreover, next time, if the OPC execution command is supplied from the system control section 150 to the integrated control section 140, the use region ARa is continuously provided to the used region illustrated in FIG. 6E in the integrated control section 140.

As described above, the integrated control section 140 performs in parallel the OPC in each channel and if it is determined that a plurality of channels of the retry target are present, the retry of the OPC is performed in parallel in the channels of the retry target. As described above, it is possible to easily set the optimum recording power of each optical head in a short amount of time when recording the information on the optical disc by using the plurality of optical heads by performing the OPC control.

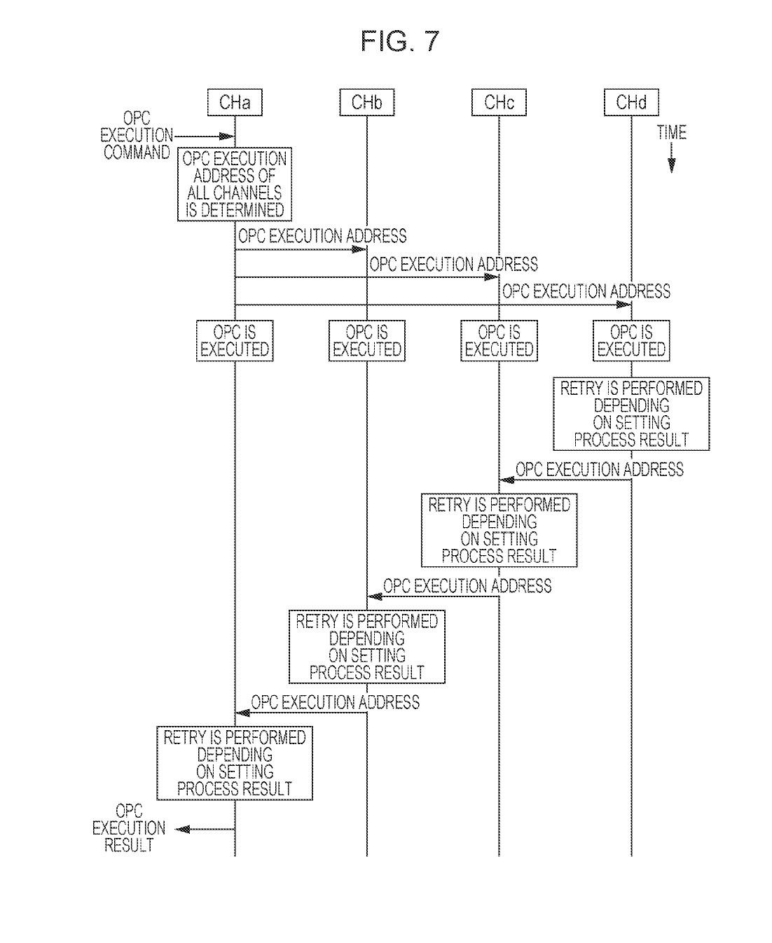

FIG. 7 is a flowchart illustrating the OPC operation that is different from the control operation of the integrated control section 140 and facilitates the setting of the OPC execution address. In the operation, the OPC operation is performed in all channels and the retry is performed for each channel depending on the setting process result. Here, if the setting of the optimum recording power is not completed in one channel, the retry is performed. Further, if the setting is completed by the retry or if the number of the retries equals or exceeds a predetermined number of times, the process is finished and notification of an end address of the use region of the OPC is provided to the next channel. In the next channel, the retry is performed depending on the setting process result. Further, in the retry, the OPC execution address is determined by using the end address of the previous channel. Thus, since the use region of the OPC can be sequentially set, the setting of the OPC execution address is facilitated. However, if the process is not completed for one channel, the process is not started for the next channel. Therefore, the number of the retries increases and the time necessary to complete the OPC in all channels is long. Further, the time necessary for completing the OPC in all channels may be further lengthened as the channels increase.

For the control operation, the integrated control section 140 performs the OPC control so as to perform the retry in parallel in the plurality of channels of the retry target. Thus, since the OPC of each channel is completed when the number of the retries reaches the predetermined number of times at the latest even if the channels are great, it is possible for the optical disc apparatus to complete the OPC process in a short amount of time. Further, since an increase in variation in the time necessary for the OPC process can be prevented, it is possible to reduce the variation in the start of the recording operation and to quickly perform the recording operation in the optical disc apparatus.

Further, for example, in Japanese Unexamined Patent Application Publication No. 2012-133844, the use region of another channel or the use region having a predetermined size for the retry is assigned so that the use region of the OPC is not duplicated on the basis of the OPC start address of one channel. In the region having a predetermined size for the retry, the use region is assigned for each channel and the use region may not be used in another channel. However, in integrated control section 140, since the use regions ARa to ARd of all channels or the use regions of the channel of the retry target are continuously provided to the used region, it is possible to use the OPC region without loss if the write-once disc is used.

### 3. Other Embodiments

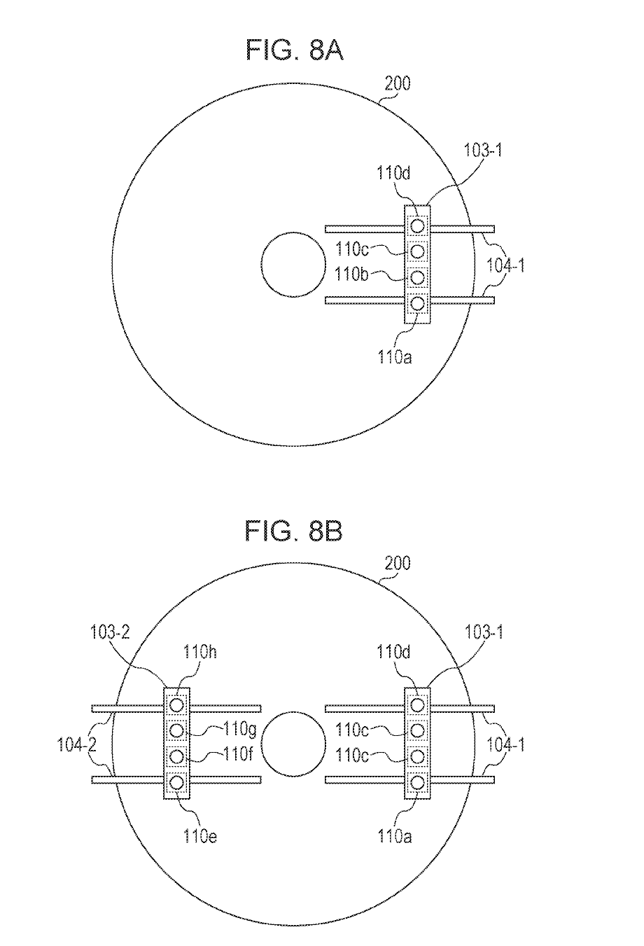

In the above embodiment, a case where the optical heads 110a and 110b are provided in the threaded carriage 103-1 and the optical heads 110c and 110d are provided in the threaded carriage 103-2, and the recording reproduction is performed in four channels is illustrated. However, the optical disc apparatus is not limited to the above embodiment. For example, as illustrated in FIG. 8A, only the threaded carriage 103-1 is provided and the optical heads 110a to 110d may be provided in the threaded carriage 103-1.

Further, for example, even if a plurality of other than four optical heads are provided and the recording reproduction is performed in a plurality of other than four channels, it is possible to perform in parallel the retry in the channels of the retry target by performing the OPC control operation illustrated in FIG. 4. Therefore, it is possible to easily respond to a change in the number of the channels, the plurality of channels or the like. For example, as illustrated in FIG. 8B, it is possible to easily respond even if the recording reproduction is performed in eight channels by respectively providing four optical heads 110a to 110d and 110e to 110h in the threaded carriages 103-1 and 103-2. Further, although not illustrated, it is possible to easily respond even if the recording reproduction is performed in eight channels by providing two optical heads in four threaded carriages by respectively newly providing two threaded carriages.

Further, in the above embodiment, the operation in a case where the write-once optical disc is used is described but it is possible to use the rewritable optical disc.

Since the rewritable optical disc can write the data even in the used region in the OPC region, as illustrated in FIG. 6B, in the integrated control section, it is not necessary to continuously provide the region to the used region. Therefore, in the integrated control section, if the rewritable optical disc is used, a random position of the OPC region is the OPC execution address in step ST1 or step ST 7 of FIG. 4. As described above, if the OPC execution address is set, it is possible to prevent the data from being recorded repeatedly in a specific region in the OPC.

Further, a series of processes described in the specification can be performed by hardware or software, or a complex configuration thereof. If the process is performed by the software, a program in which a processing sequence is recorded is executed by being installed in a memory in a computer built in dedicated hardware. Otherwise, it is possible to execute the program by installing the program in a general-purpose computer capable of executing various processes.

For example, it is possible to record the program in advance on a hard disk, a Solid State Drive (SSD), or a Read Only Mechanism (ROM) as a recording medium. Otherwise, it is possible to temporarily or permanently store (record) the program in a removable recording medium such as a flexible disc, a Compact Disc Read Only Memory (CD-ROM), a Magneto Optical (MO) disc, a Digital Versatile Disc (DVD), a Blu-Ray Disc (BD) (registered trademark), an electromagnetic disc, and a semiconductor memory card. The removable recording medium can be provided as so-called package software.

Further, the program may be transferred by wire or wirelessly from a download site to the computer through a network such as a Local Area Network (LAN) or the Internet in addition to be installed on the computer from the removable recording medium. On the computer, it is possible to receive the program that is transferred in such a manner, and install the program in the recording medium such as a built-in hard disk.

Moreover, the present technology is not to be construed as limited to the above embodiments. The embodiments of the present technology disclose the present technology as forms of examples and it is obvious that those skilled in the art can make modifications and substitutions of the embodiments without departing from the scope of the present technique. That is, in order to determine the scope of the present technology, it should be considered the scope of the appended claims.

Further, the optical disc apparatus of an embodiment of the present technology can also take the following configuration.

(1) An optical disc apparatus including: a plurality of optical heads; an optical head control section that performs a first optical output configuration process for each of the plurality of optical heads by using a test writing region provided in an optical disc, wherein the first optical output configuration process sets an optimum recording power for each of the plurality of optical heads; and an integrated control section that controls the optical head control section such that the first optical output configuration process for each of the plurality of optical heads is performed in parallel and a second optical output configuration process is performed for at least one optical head of the plurality of optical heads based on a result of the first optical output configuration process.

(2) The optical disc apparatus according to (1), in which the second optical output configuration process is performed for two or more optical heads of the plurality of optical heads in parallel based on a result of the first optical output configuration process.

(3) The optical disc apparatus according to (1) or (2), in which the integrated control section determines a test writing region for each of the plurality of optical heads.

(4) The optical disc apparatus according to (1) to (3), in which the integrated control section controls a number of times in which the optical output configuration process is performed based on a predetermined number.

(5) The optical disc apparatus according to any one of (1) to (4), in which the integrated control section determines that the second optical output configuration process is to be performed based on a result indicating that the optimum recording power has not been set during the first optical output configuration process.

(6) The optical disc apparatus according to any one of (1) to (5), in which the optical head control section obtains a writing quality during the optical output configuration process based on the test writing region and sets the optimum recording power for the optical head control section if the writing quality satisfies a predetermined quality.

(7) The optical disc apparatus according to any one of (1) to (6), in which the optical head control section obtains a writing quality during the optical output configuration process based on the test writing region and does not set the optimum recording power for the optical head control section if the writing quality does not satisfy a predetermined quality.

(8) The optical disc apparatus according to any one of (1) to (7), in which the optical disc is a write-once optical disc, and the integrated control section continuously sets a use region that is used for the test writing region for the optical output setting process to a used.

(9) The optical disc apparatus according to any one of (1) to (8), in which wherein the optical disc is a rewritable optical disc, and the integrated control section randomly determines a use region that is used as the test writing region for the optical output setting process.

(10) The optical disc apparatus according to any one of (1) to (9), in which the integrated control section performs a process for distributing information to be recorded on the optical disc to the plurality of optical heads and wherein the integrated control section performs a process for reading information from the optical disc in parallel and returning the information that is read from the optical disc in parallel to a sequential order in which the information exists on the optical disc.

(11) The optical disc apparatus according to any one of (1) to (10), in which a third optical output configuration process is performed for at least one optical head of the plurality of optical heads based on a result of the second optical output configuration process.

(12) An optical disc recording method including: performing, in parallel, a first optical output configuration process for each of a plurality of optical heads by using a test writing region provided in the optical disc, wherein the first optical output configuration process sets an optimum recording power for at least one of the plurality of optical heads in an optical head control section; and performing a second optical output configuration process for at least one optical head of the plurality of optical heads, based on a result of the first optical output configuration.

(13) The optical disc recording method according to (12), further comprising performing the second optical output configuration process for two or more optical heads of the plurality of optical heads in parallel based on a result of the first optical output configuration process.

(14) The optical disc recording method according to (12) or (13), further comprising determining a test writing region for each of the plurality of optical heads.

(15) The optical disc recording method according to any one of (12) to (14), further comprising determining that the second optical output configuration process is to be performed based on a result indicating that the optimum recording power has not been set during the first optical output configuration process.

(16) The optical disc recording method according to any one of (12) to (15), further comprising obtaining a writing quality during the first optical output configuration process based on the test writing region and setting the optimum recording power for the optical head if the writing quality satisfies a predetermined quality.

(17) The optical disc recording method according to any one of (12) to (16), wherein when the optical disc is a write-once optical disc, an integrated control section continuously sets a use region that is used for the test writing region for the optical output setting process to used.

(18) The optical disc recording method according to any one of (12) to (17), wherein when the optical disc is a rewritable optical disc an integrated control section randomly determines a use region that is used as the test writing region for the optical output setting process.

(19) The optical disc recording method according to any one of (12) to (18), further comprising modifying at least one of a range of recording power and test data during the second optical output configuration process.

(20) The optical disc recording method according to any one of (12) to (19), further comprising performing a third optical output configuration process for at least one optical head of the plurality of optical heads based on a result of the second optical output configuration process.

What is claimed is:

1. An optical disc apparatus comprising:
a plurality of optical heads;
an optical head control section that performs a first optical output configuration process for each of the plurality of optical heads by using a test writing region provided in an optical disc, wherein the first optical output configuration process sets an optimum recording power for each of the plurality of optical heads; and
an integrated control section that controls the optical head control section such that the first optical output configuration process for each of the plurality of optical heads is performed in parallel and a second optical output configuration process is performed for at least one optical head of the plurality of optical heads based on a result of the first optical output configuration process.

2. The optical disc apparatus according to claim 1,
wherein the second optical output configuration process is performed for two or more optical heads of the plurality of optical heads in parallel based on a result of the first optical output configuration process.

3. The optical disc apparatus according to claim 1, wherein the integrated control section determines a test writing region for each of the plurality of optical heads.

4. The optical disc apparatus according to claim 1,
wherein the integrated control section controls a number of times in which the optical output configuration process is performed based on a predetermined number.

5. The optical disc apparatus according to claim 1,
wherein the integrated control section determines that the second optical output configuration process is to be performed based on a result indicating that the optimum recording power has not been set during the first optical output configuration process.

6. The optical disc apparatus according to claim 1,
wherein the optical head control section obtains a writing quality during the first optical output configuration process based on the test writing region and sets the optimum recording power for the optical head if the writing quality satisfies a predetermined quality.

7. The optical disc apparatus according to claim 1,
wherein the optical head control section obtains a writing quality during the first optical output configuration process based on the test writing region and does not set the optimum recording power for the optical head if the writing quality does not satisfy a predetermined quality.

8. The optical disc apparatus according to claim 1,
wherein the optical disc is a write-once optical disc, and
wherein the integrated control section continuously sets a use region that is used for the test writing region for the optical output setting process to a used.

9. The optical disc apparatus according to claim 1,
wherein the optical disc is a rewritable optical disc, and
wherein the integrated control section randomly determines a use region that is used as the test writing region for the optical output setting process.

10. The optical disc apparatus according to claim 1,
wherein the integrated control section performs a process for distributing information to be recorded on the optical disc to the plurality of optical heads and wherein the integrated control section performs a process for reading information from the optical disc in parallel and returning the information that is read from the optical disc in parallel to a sequential order in which the information exists on the optical disc.

11. The optical disc apparatus according to claim 1,
wherein a third optical output configuration process is performed for at least one optical head of the plurality of optical heads based on a result of the second optical output configuration process.

12. An optical disc recording method comprising:
performing, in parallel, a first optical output configuration process for each of a plurality of optical heads by using a test writing region provided in the optical disc, wherein the first optical output configuration process sets an optimum recording power for at least one of the plurality of optical heads in an optical head control section; and
performing a second optical output configuration process for at least one optical head of the plurality of optical heads, based on a result of the first optical output configuration.

13. The optical disc recording method according to claim 12, further comprising performing the second optical output configuration process for two or more optical heads of the plurality of optical heads in parallel based on a result of the first optical output configuration process.

14. The optical disc recording method according to claim 12, further comprising determining a test writing region for each of the plurality of optical heads.

15. The optical disc recording method according to claim 12, further comprising determining that the second optical output configuration process is to be performed based on a result indicating that the optimum recording power has not been set during the first optical output configuration process.

16. The optical disc recording method according to claim 12, further comprising obtaining a writing quality during the first optical output configuration process based on the test writing region and setting the optimum recording power for the optical head if the writing quality satisfies a predetermined quality.

17. The optical disc recording method according to claim 12, wherein when the optical disc is a write-once optical disc, an integrated control section continuously sets a test writing region used for the optical output setting process to previously used.

18. The optical disc recording method according to claim 12, wherein when the optical disc is a rewritable optical disc an integrated control section randomly determines a use region that is used as the test writing region for the optical output setting process.

19. The optical disc recording method according to claim 12, further comprising modifying at least one of a range of recording power and test data during the second optical output configuration process.

20. The optical disc recording method according to claim 12, further comprising performing a third optical output configuration process for at least one optical head of the plurality of optical heads based on a result of the second optical output configuration process.
